(19) United States
(12) Patent Application Publication
(10) Pub. No.: US 2019/0220966 A1
(43) Pub. Date: Jul. 18, 2019

(54) INSPECTION DEVICE

(71) Applicant: DENSO CORPORATION, Kariya-city (JP)

(72) Inventors: Kohei NAKAMURA, Kariya-city (JP); Katsuhiro MIYAGAKI, Kariya-city (JP); Hiroyuki IWATSUKI, Kariya-city (JP); Shinji KATO, Kariya-city (JP); Masaru HORIGUCHI, Kariya-city (JP)

(21) Appl. No.: 16/362,800

(22) Filed: Mar. 25, 2019

Related U.S. Application Data
(63) Continuation of application No. PCT/JP2017/034895, filed on Sep. 27, 2017.

(30) Foreign Application Priority Data
Sep. 28, 2016 (JP) 2016-190101

(51) Int. Cl. G06T 7/00

(52) U.S. Cl. CPC G06T 7/001; G06T 2207/20081; G06T 2207/30168; G06T 2207/30164

(57) ABSTRACT

An inspection device includes an image acquisition unit that acquires image data including an inspection object, the image data being captured by a wearable camera, a characteristic amount calculation unit that calculates a characteristic amount capable of specifying the inspection object in the image data as a calculated characteristic amount, and a condition checking unit that compares the calculated characteristic amount with a learning characteristic amount stored in a learning information storage unit to check the condition of the inspection object.

### CROSS REFERENCE TO RELATED APPLICATIONS

The present application is a continuation application of International Patent Application No. PCT/JP2017/034895 filed on Sep. 27, 2017, which designated the United States and claims the benefit of priority from Japanese Patent Application No. 2016-190101 filed on Sep. 28, 2016. The entire disclosures of the above applications are incorporated herein by reference.

### TECHNICAL FIELD

The present disclosure relates to an inspection device.

### BACKGROUND

In the manufacturing process of a product, the quality of an object to be inspected such as a product at an intermediate stage (hereinafter referred to as “workpiece”) or a finished product may be visually inspected by a worker. In this case, a wearable camera may support the inspection work by capturing images.

### SUMMARY

An inspection device of the present disclosure may include an image acquisition unit that acquires image data including an inspection object, the image data being captured by a wearable camera attached to a worker inspecting the inspection object, a characteristic amount calculation unit that calculates a characteristic amount capable of specifying the inspection object in the image data as a calculated characteristic amount, and a condition checking unit that compares the calculated characteristic amount with a learning characteristic amount stored in a learning information storage unit to check the condition of the inspection object.

### BRIEF DESCRIPTION OF DRAWINGS

FIG. 1 is a diagram for explaining a usage state of an inspection device according to an embodiment.

FIG. 2 is a block configuration diagram showing the configuration of the inspection device shown in FIG. 1.

FIG. 3 is a block configuration diagram showing a functional configuration of a controller shown in FIG. 2.

FIG. 4 is a diagram for explaining an example of information stored in a learning information storage unit shown in FIG. 3.

FIG. 5 is a diagram for explaining image correction for an inspection device according to an embodiment.

### DETAILED DESCRIPTION

Hereinafter, the present embodiments will be described with reference to the attached drawings. In order to facilitate the ease of understanding, the same reference numerals are attached to the same constituent elements in each drawing where possible, and redundant explanations are omitted.

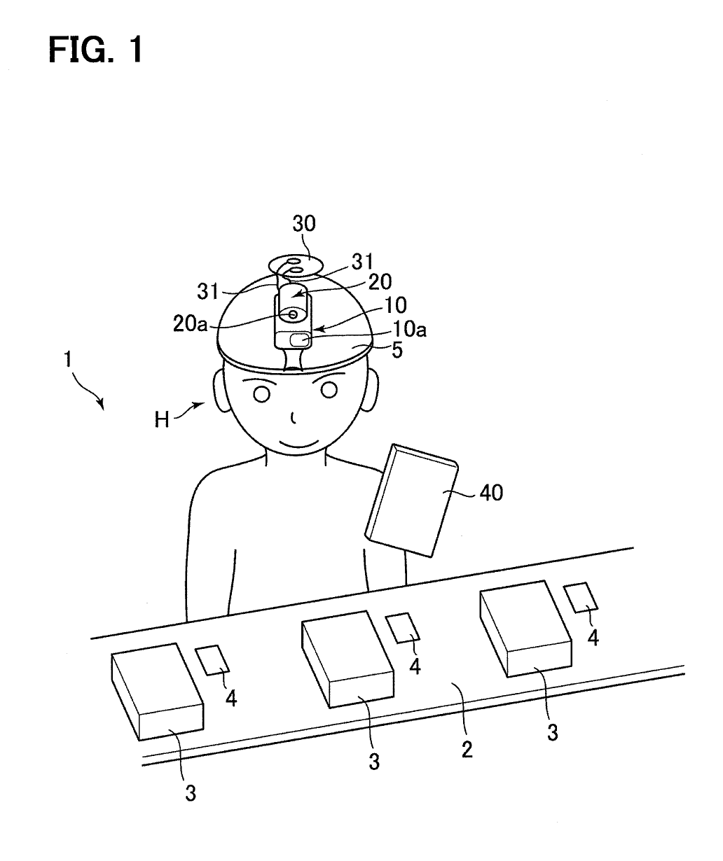

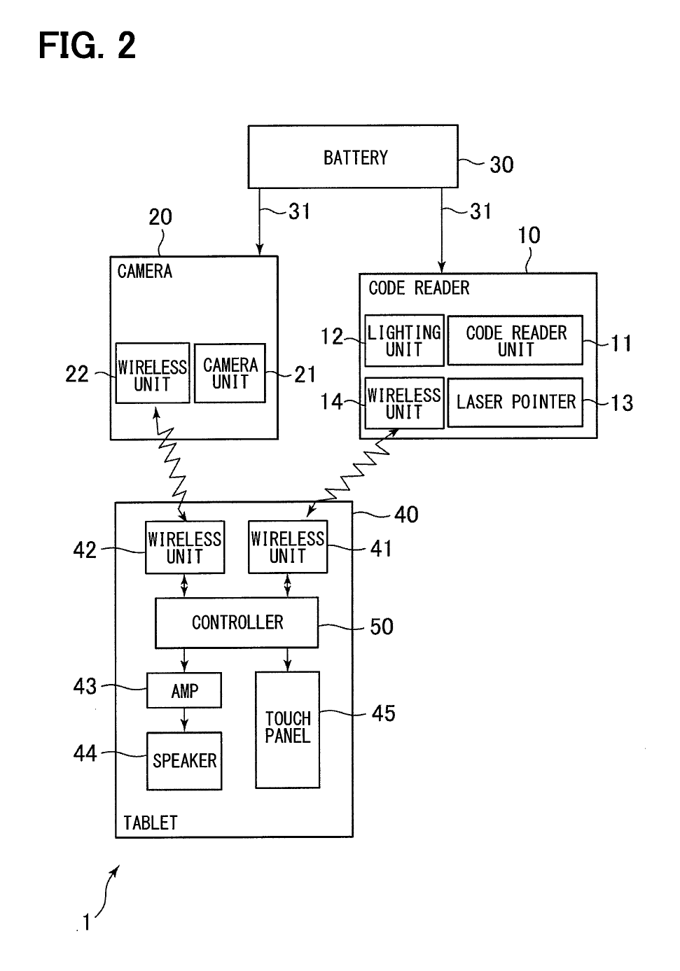

With reference to FIG. 1 and FIG. 2, an example of an inspection work to which an inspection device 1 according to an embodiment is applied and a schematic configuration of the inspection device 1 will be described.

As shown in FIG. 1, the inspection device 1 according to the embodiment is used in the manufacturing process of a product such as a heat exchanger. Specifically, the inspection device 1 is used in an inspection work for determining whether or not an object to be inspected, such as the workpiece 3 at an intermediate manufacturing stage or a finished product, are good products.

A worker H of the inspection work inspects whether or not the workpieces 3 sequentially conveyed by a conveyor 2 are good. On the conveyor 2, a plurality of sets of workpieces 3 and signboards 4 are placed. The conveyor 2 conveys these sets so that a plurality of the sets are sequentially arranged in front of the workers H. The signboard 4 is arranged near its corresponding workpiece 3, and a code indicating the type of the workpiece 3 is displayed on that signboard 4.

The worker H can perform the above-described inspection work using the inspection device 1 of the present embodiment. As shown in FIGS. 1 and 2, the inspection device 1 includes a code reader 10, a wearable camera 20, a battery 30, and a tablet 40.

As shown in FIG. 2, the code reader 10 includes a code reader unit 11, a lighting unit 12, a laser pointer unit 13, and a wireless unit 14.

The code reader unit 11 a well known optical code reader including a light source that irradiates light. Light is emitted from the light source through lens 10a, reflected by the signboard 4, and received through the lens 10a. The code reader unit 11 reads this reflected light to read codes. Here, the signboard 4 of the present embodiment is a display board on which a code is displayed. The code is an identification indicator indicating the type of the workpiece 3. Various codes, such as a QR code (registered trademark) or a bar code, may be used as the code.

The lighting unit 12 illuminates the workpiece 3 and its surroundings through the lens 10a.

The laser pointer unit 13 irradiates a laser beam as a pointer through the lens 10a. Thus, the laser pointer unit 13 assists the worker H to recognize a target reading area in which the code reader unit 11 reads codes. In the present embodiment, the region irradiated with the laser beam by the laser pointer unit 13 is set to coincide with the target reading area of the code reader unit 11.

The wireless unit 14 is composed of an antenna, a wireless circuit, and the like, and wirelessly communicates with the wireless unit 41 of the tablet 40.

The wearable camera 20 is a compact camera which is attached to a body or the like and is intended to capture images in a hands-free manner. As shown in FIG. 2, the wearable camera 20 includes a camera unit 21 and a wireless unit 22. The camera unit 21 captures images of the workpiece 3 as an target imaging object using the light received via lens 20a. The wireless unit 22 is composed of an antenna, a wireless circuit, and the like, and wirelessly communicates with the wireless unit 42 of the tablet 40.

The battery 30 is a secondary battery that supplies direct current power to the code reader 10 and the camera 20 via a harness 31 or the like.

In the present embodiment, as shown in FIG. 1, the code reader 10, the wearable camera 20, and the battery 30 are mounted on a hat 5 to be worn by the worker H. Further, the code reader 10 and the wearable camera 20 are installed on the hat 5 of the worker H so that the lens 10a of the code reader 10 and the lens 20a of the wearable camera 20 are disposed facing the front of the worker H.

The tablet 40 is a portable terminal configured to be carried by the worker H. As shown in FIG. 2, the tablet 40 includes wireless units 41 and 42, an amplifier 43, a speaker 44, a touch panel 45, and a controller 50.

The wireless units 41 and 42 are composed of an antenna, a wireless circuit, and the like. The wireless unit 41 wirelessly communicates with the wireless unit 14 of the code reader 10. The wireless unit 42 wirelessly communicates with the wireless unit 22 of the wearable camera 20. In the present embodiment, various types of short range wireless communications may be used for wireless communication between the wireless units. Bluetooth (registered trademark) or Wi-Fi (registered trademark) can be used as the short-range wireless communication.

The amplifier 43 amplifies the voltage of the analog signal output from the controller 50 and outputs an amplified signal. The speaker 44 converts the amplified signal output from the amplifier 43 into sound and outputs the sound. The touch panel 45 is a display device combining a transparent key input operation unit and a display panel.

The controller 50 is a device that controls the operation of each part of the inspection device 1 related to the above-described inspection work. The controller 50 is physically a microcontroller composed of a CPU, a memory, digital-analog conversion circuits, and the like. The controller 50 executes an inspection process in accordance with a computer program stored in advance in the memory. The inspection process is a determination process of determining whether or not the workpiece 3 is a non-defective product based on the code acquired from the code reader 10 and the captured image acquired by the wearable camera 20.

In the memory, a plurality of kinds of reference images are stored in advance. The reference images include still images or videos, and are used for determining whether or not the workpiece 3 is a non-defective item. Each reference image includes a non-defective product image showing a workpiece 3 which is a non-defective product and a defective product image showing a defective workpiece 3. The digital-analog conversion circuit outputs an analog signal representing a sound based on a command of the CPU.

In the present embodiment, the tablet 40 is carried by the worker H, for example, stored in a pocket of the worker H, or is placed in the vicinity of the worker H.

By using the inspection device 1 configured in this way, the standard work for the inspection process for the workpiece 3 as performed by the worker H may be, for example, performed as follows.

First, the worker H directs their head to face the signboard 4, so that the code reader 10 attached to the hat 5 reads the code from the signboard 4. Next, the head is directed to face the workpiece 3, and the wearable camera 20 attached to the hat 5 likewise captures the image of the workpiece 3 to acquire the captured image. That is, using the code reader 10 reading the code from the signboard 4 as a trigger, the wearable camera 20 acquires the captured image of the workpiece 3. The tablet 40 receives the code from the code reader 10 via wireless communication and receives the captured image from the wearable camera 20.

The controller 50 in the tablet 40 selects the reference image corresponding to the received code from the plurality of types of reference images stored in advance in the memory as described above. The controller 50 compares the captured image of the workpiece 3 with the reference image to determine whether or not the workpiece 3 is a non-defective product. In addition, the controller 50 notifies the worker H of the result of pass/fail determination of the workpiece 3 via sound information or visual information using the speaker 44 of the tablet 40 or the touch panel 45 of the tablet 40.

The worker H continues to the next work based on the information of the determination result outputted from the tablet 40. For example, if it is determined that the workpiece 3 is a non-defective product, the next workpiece 3 on the conveyor 2 is inspected.

The inspection device 1 configured as described above is carried by the worker H as a wearable device so that both hands of the worker H are free. With the above configuration, the inspection device 1 can automatically perform the inspection work for the inspection object without requiring any operation using the hands of the worker H, and supports the inspection work of the worker H so that the burden on the worker H can be reduced. In addition, since the worker H is in a hands-free state during the inspection work, the worker H can perform other work (such as screw tightening) aside from the inspection while performing the inspection work of the workpiece 3, and efficiency can be improved.

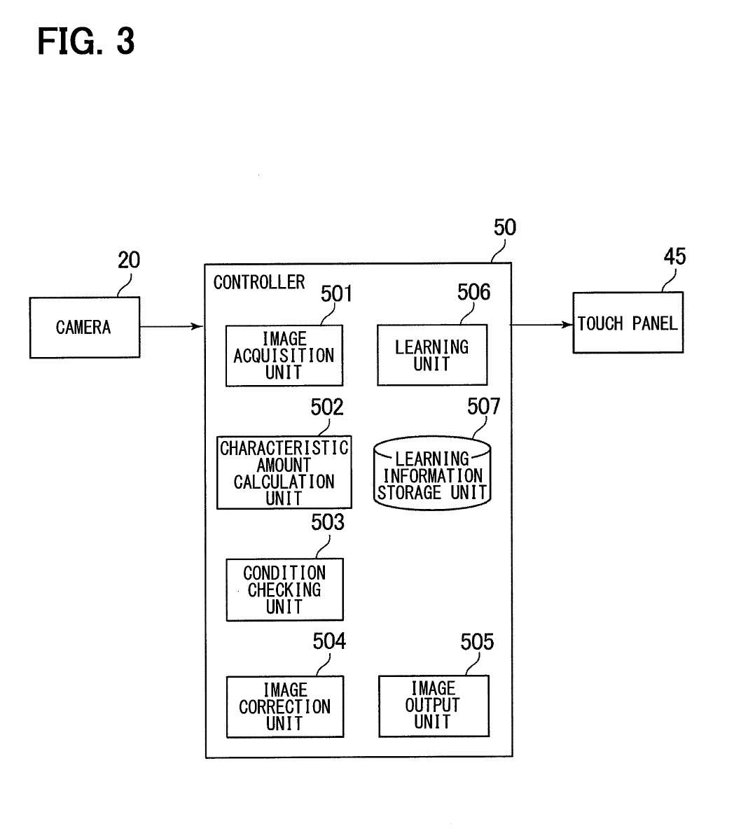

Next, functional components of the controller 50 and their operations will be described with reference to FIG. 3. The controller 50 includes, as functional components, an image acquisition unit 501, a characteristic amount calculation unit 502, a condition checking unit 503, an image correction unit 504, an image output unit 505, a learning unit 506, and a learning information storage unit 507.

The image acquisition unit 501 acquires image data output from the wearable camera 20.

The characteristic amount calculation unit 502 is a portion that calculates a characteristic amount in the image data capable of specifying the workpiece 3, i.e., the object to be inspected, as a calculated characteristic amount. The characteristic amount is a numerical value calculated from the dimensions of each part of the workpiece 3, the shape of each part of the workpiece 3, etc., and is a numerical value capable of specifying the workpiece 3. The characteristic amount is appropriately determined according to the use or shape of the workpiece 3 and the like. As an example of a characteristic amount, a numerical value that specifies an outline of the outer shape of the workpiece 3 obtained from the image data of the workpiece 3 may be used. The characteristic amount of the workpiece 3 is unambiguously determined according to a deviation amount from a standard position of the workpiece 3.

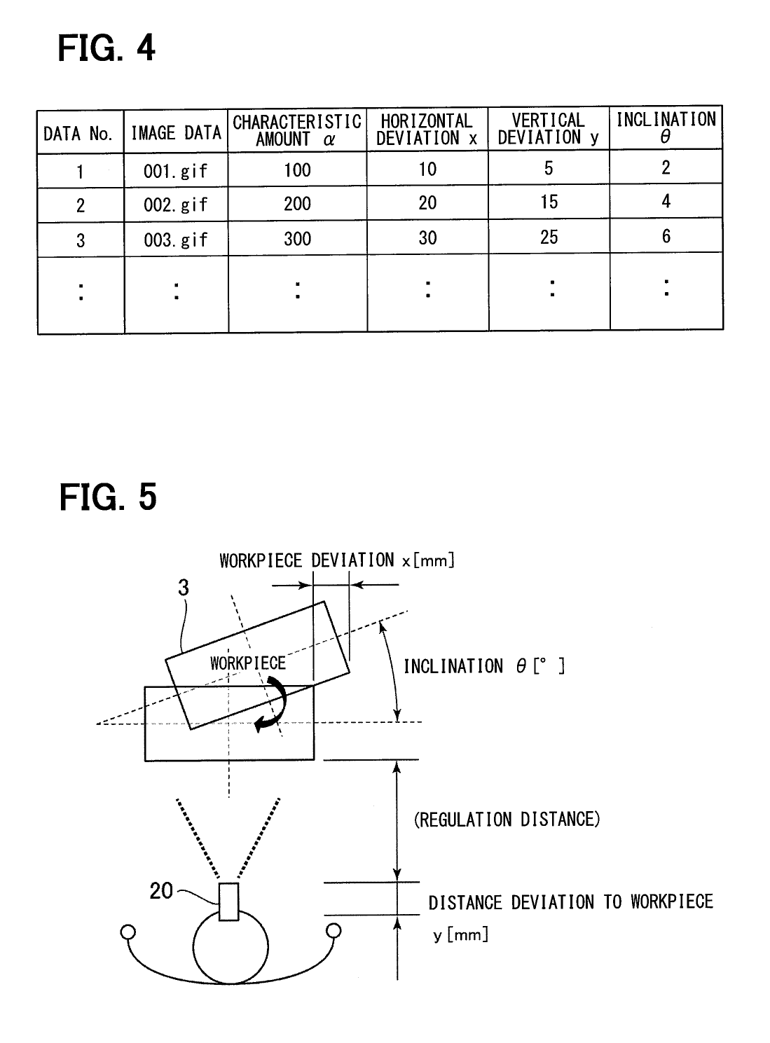

The condition checking unit 503 compares the calculated characteristic amount with a learning characteristic amount stored in the learning information storage unit 507 to check the condition of the workpiece 3 as the object to be inspected. An example of the learning characteristic amount stored in the learning information storage unit 507 is shown in FIG. 4.

As shown in FIG. 4, the learning information storage unit 507 stores an image data file, a characteristic amount α, a workpiece horizontal offset x, a workpiece vertical deviation y, and a workpiece inclination θ in association with each other. The workpiece horizontal offset x, workpiece vertical deviation y, and workpiece inclination θ are as shown in FIG. 5.

Based on the image data and the checking result of the condition checking unit 503, the image correction unit 504 determines the workpiece horizontal offset x, the workpiece vertical deviation y, and the workpiece inclination θ, and corrects the image data. According to the example shown in FIG. 4, if the comparison result of the condition checking unit 503 is that characteristic amount α=100, then it is determined that the workpiece horizontal offset x=10, the workpiece vertical deviation y=5, and the workpiece inclination θ=2.

The image output unit 505 outputs the corrected image data, which is corrected by the image correction unit 504, to the touch panel 45. The touch panel 45 displays the corrected image data.

The learning unit 506 additionally updates the learning characteristic amount stored in the learning information storage unit 507. The learning unit 506 may calculate the learning characteristic amount from the image data captured by the inspection device 1 and store it in the learning information storage unit 507. The learning unit 506 may also store separately calculated learning characteristic amounts in the learning information storage unit 507, without being dependent on the image data captured by the inspection device 1. In addition, the learning characteristic amount may include information specifying non-defective items or information identifying defective items. Although the actual captured image data is mostly directed toward non-defective items, it is possible to intentionally include information specifying defective products by using separately calculated learning characteristic amounts in order to increase the number of samples.

As described above, the inspection device 1 according to the present embodiment includes the image acquisition unit 501 that acquires image data including the inspection object workpiece 3, the image data being captured by the wearable camera 20 attached to the worker H inspecting the workpiece 3, the characteristic amount calculation unit 502 that calculates a characteristic amount capable of specifying the workpiece 3 in the image data as a calculated characteristic amount, and the condition checking unit 503 that compares the calculated characteristic amount with a learning characteristic amount stored in the learning information storage unit 507 to check the condition of the workpiece 3.

For example, consider an inspection device of a comparative example in which a wearable camera is used to capture images of an inspection object and those captured images are used directly to identify defective items. In this case, it is ideal that the wearable camera and the object to be inspected are kept at a constant distance and constant angle from each other. However, in reality, due to differences in how to arrange the objects to be inspected on the inspection table, or due to variations in the angle of each worker with respect to the object to be inspected, it is difficult to ensure a predetermined distance and a predetermined angle. In order to correct the deviation of the worker with respect to the object to be inspected, it is conceivable to correct the image captured by the wearable camera. However, if it is attempted to correct the captured images with high accuracy, computational load increases and there is a risk of hindering rapid inspection.

Here, according to the present embodiment, a calculated characteristic amount is calculated and compared with learning characteristic amounts stored in advance. Accordingly, it is possible check the condition of the workpiece 3, which is the object to be inspected, while reducing computation load as compared to individually calculating offset amounts with respect to a inspection target workpiece 3 in a standard position. As such, the inspection device 1 of the present embodiment is capable of accurately and quickly inspecting an object to be inspected even when a worker can not ensure a predetermined angle and a predetermined distance with respect to the object to be inspected.

Further, in the present embodiment, the image correction unit 504 is provided for correcting the image data based on the checking result of the condition checking unit 503. The calculated characteristic amount is calculated and compared with the pre-stored learning characteristic amount. Accordingly, it is possible to correct the acquired image data to correspond to the image data corresponding to the pre-stored learning characteristic amount.

Further, in the present embodiment, the learning unit 506 is provided to update the learning characteristic amounts stored in the learning information storage unit 507. Since the learning characteristic amounts can be further updated by the learning unit 506, the number of samples can be increased, and the verification accuracy of the condition checking unit 503 can be improved.

Further, in the present embodiment, the learning unit 506 can also update the numerical values associated with the learning characteristic amounts corresponding to the calculated characteristic amount based on the result of the check by the condition checking unit 503. By checking the calculated characteristic amount against the learning characteristic amounts, it is possible to avoid separately calculate the workpiece horizontal offset x, the workpiece vertical deviation y, and the workpiece inclination θ. However, it is assumed that in some cases, it may be necessary to reconfirm the numerical values associated with the learning characteristic amounts and update the numerical values. Therefore, it is also possible to re-calculate and renew the numerical values, such as the workpiece horizontal offset x, the workpiece vertical deviation y, and the workpiece inclination θ associated with the learning characteristic amounts, based on the check result of the condition checking unit 503.

Further, in the present embodiment, the learning unit 506 can store, in the learning information storage unit 507, learning characteristic amounts which are characteristic amounts corresponding to nonstandard items of the inspection target workpiece 3. Since data of nonstandard items such as defective products cannot be acquired by actual measurement in many cases, the learning unit 506 can calculate the characteristic amounts corresponding to those nonstandard items and store the characteristic amounts in the learning information storage unit 507.

The present embodiment has been described above with reference to the specific examples. However, the present disclosure is not limited to those specific examples. Those specific examples subjected to an appropriate design change by those skilled in the art are also encompassed in the scope of the present disclosure as long as the changed examples have the features of the present disclosure. Each element included in each of the specific examples described above and the placement, condition, shape, and the like of each element are not limited to those illustrated, and can be changed as appropriate. The combinations of elements included in each of the above described specific examples can be appropriately modified as long as no technical inconsistency occurs.

1. An inspection device, comprising:
an image acquisition unit that acquires image data including an inspection object, the image data being captured by a wearable camera attached to a worker inspecting the inspection object;
a characteristic amount calculation unit that calculates a characteristic amount capable of specifying the inspection object in the image data as a calculated characteristic amount; and
a condition checking unit that compares the calculated characteristic amount with a learning characteristic amount stored in a learning information storage unit to check a condition of the inspection object.

2. The inspection device according to claim 1, further comprising:
an image correction unit that corrects the image data based on the checking result of the condition checking unit.

3. The inspection device according to claim 1, further comprising:
a learning unit that additionally updates the learning characteristic amounts stored in the learning information storage unit.

4. The inspection device according to claim 3, wherein
the learning unit is configured to update numerical values associated with the learning characteristic amounts corresponding to the calculated characteristic amount based on the result of the check by the condition checking unit.

5. The inspection device according to claim 3, wherein
the learning unit is configured to store, in the learning information storage unit, learning characteristic amounts which are characteristic amounts corresponding to nonstandard items of the object.

6. An inspection device for a worker that performs inspection work, comprising:
a wearable camera configured to be attached to the worker; and
a controller including a processor and a memory, the controller being coupled to the wearable camera, wherein
the controller is programmed to:
control the wearable camera to acquire image data of an inspection object,
analyze the acquired image data to calculate a characteristic amount of the inspection object in the image data, the characteristic amount being a numerical value representation of a particular physical attribute of the inspection object in the image data, and
compare the calculated characteristic amount with a learning characteristic amount stored in the memory to check a condition of the inspection object.
